(19) United States
(12) Patent Application Publication
(10) Pub. No.: US 2008/0014042 A1
(43) Pub. Date: Jan. 17, 2008

(54) Fastener With Tool Retainer

(76) Inventor: Robert V. De France, Poughkeepsie, NY (US)

Correspondence Address: HARRINGTON & SMITH, PC, 4 RESEARCH DRIVE, SHELTON, CT, 06484-6212, US

(21) Appl. No.: 11/767,038

(22) Filed: Jun. 22, 2007

Related U.S. Application Data
(60) Provisional application No. 60/830,248, filed on Jul. 12, 2006.

(51) Int. Cl. F16B 31/00; F16B 37/08

(52) U.S. Cl. 411/2; 411/432

(57) ABSTRACT

Disclosed herein is a fastener nut. The fastener nut includes a first section, a second section, and a third section. The first section has a threaded inner diameter. The second section has an outer annular groove. The third section is between the first section and the second section. The first section, the second section, and the third section are integrally formed together as a one-piece member. The second section is configured to be removed from the first section at the third section.

### CROSS REFERENCE TO RELATED APPLICATION

This application claims priority under 35 U.S.C. §119(e) to U.S. provisional patent application No. 60/830,248 filed Jul. 12, 2006 which is hereby incorporated by reference in its entirety.

### BACKGROUND OF THE INVENTION

1. Field of the Invention

The present invention relates to a fastener and, more particularly, to a fastener having a retainer for retaining the fastener with a tool.

2. Brief Description of Prior Developments

Break-away or break-off fasteners and fastener assemblies are well known in the art. These fasteners and fastener assemblies generally comprise a portion, or portions, that break away at a predetermined torque. For example, European Patent Application No. EP 1,724,473 discloses a fastener bolt comprising break-off points at the bolt shank. One drawback to conventional configurations is that after the predetermined torque is reached, the break-away or break-off portion is free from the fastener and can easily drop or fall from the fastening tool. This can slow assembly times (and thus increase assembly costs) as the break-away/break-off portion may fall to a location which is not easily accessible. Additionally, foreign objects or debris, such as the break-away/break-off nut portion, may cause damage to the assembled component. In order to minimize and/or prevent damage to the components, there is a desire to provide a fastener having a robust configuration which is retained within the fastening tool after the predetermined force is reached.

### SUMMARY OF THE INVENTION

In accordance with one aspect of the present invention, a fastener nut is disclosed. The fastener nut includes a first section, a second section, and a third section. The first section has a threaded inner diameter. The second section has an outer annular groove. The third section is between the first section and the second section. The first section, the second section, and the third section are integrally formed together as a one-piece member. The second section is configured to be removed from the first section at the third section.

In accordance with another aspect of the present invention, a fastener assembly is disclosed. The fastener assembly includes a nut and a retaining member. The nut includes a first section and a second section. The first section has a threaded inner diameter. The second section is configured to break away from the first section. The retaining member is connected to the second section. The retaining member is configured to provide an interference fit between the second section and a mating tool.

In accordance with yet another aspect of the present invention, a fastener assembly is disclosed. The fastener assembly includes a nut and a retaining member. The nut includes a first section, a second section, and a third section. The first section is configured to receive a bolt. The second section has an outer annular groove. The third section is between the first section and the second section. The third section is configured to fracture at a predetermined force. The retaining member disposed within the outer annular groove.

### BRIEF DESCRIPTION OF THE DRAWINGS

The foregoing aspects and other features of the present invention are explained in the following description, taken in connection with the accompanying drawings, wherein:

FIG. 1 is a perspective view of a fastener comprising features of the invention;

FIG. 2 is a side view of the nut used in the fastener shown in FIG. 1;

FIG. 3 is an end view of the nut shown in FIG. 2;

FIG. 4 is a cross sectional view of the nut shown in FIG. 2; and

FIG. 5 is an end view of a second section of the nut used in the fastener shown in FIG. 1, wherein the nut is retained within a tool.

### DETAILED DESCRIPTION OF THE PREFERRED EMBODIMENT

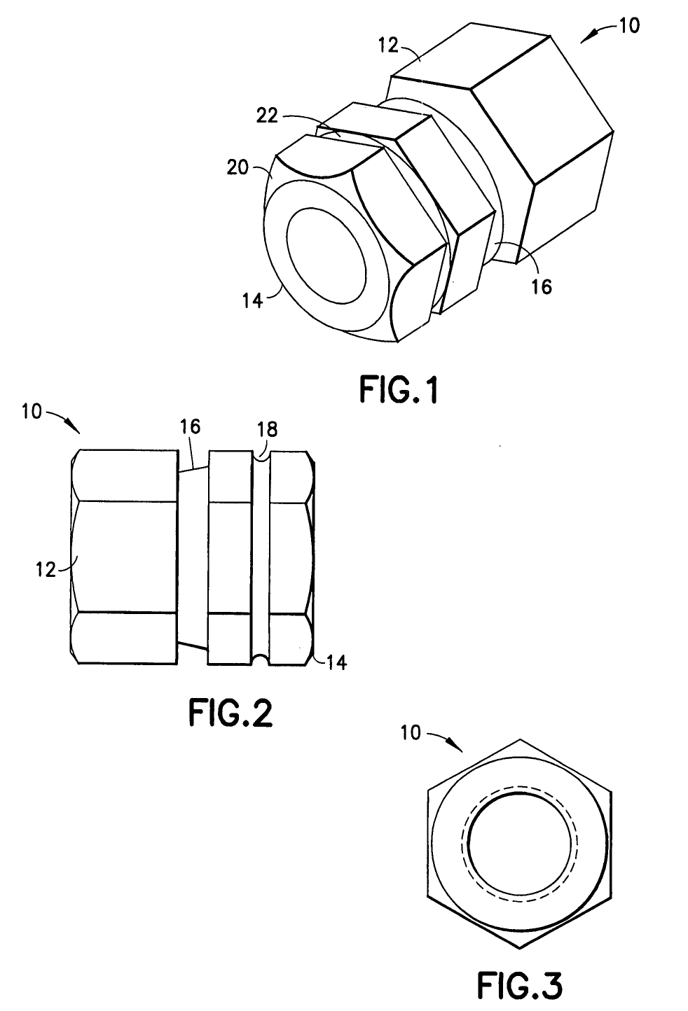

Referring to FIG. 1, there is shown a perspective view of a fastener 10 incorporating features of the present invention. Although the present invention will be described with reference to the exemplary embodiment shown in the drawings, it should be understood that the present invention can be embodied in many alternate forms of embodiments. In addition, any suitable size, shape or type of elements or materials could be used.

Referring now also to FIG. 2, the fastener or fastener assembly 10 in this embodiment comprises a nut 20 adapted to be screwed onto a threaded member (not shown), such as a bolt member of an electrical connector for example, and a retainer member 22. For example, the nut could be used in an electrical connector such as shown in U.S. patent application Ser. No. 11/114,571 which is hereby incorporated by reference in its entirety. However, the fastener 10 could be used with any suitable type of mating fastener and/or any suitable type of environment other than an electrical connector environment. The nut 20, in this embodiment, is a break-away nut comprising a first section 12, a second section 14 and a third section 16 connecting the second section 14 to the first section 12. The first section 12, the second section 14, and the third section 16 may be integrally formed together as a one-piece member. The third section 16 is designed to break or fracture in order to allow the second section 14 to be removed from the first section 12 at a predetermined force. Thus, the second section 14 forms a break-off section which is severable from the first section 12 when the third section 16 breaks.

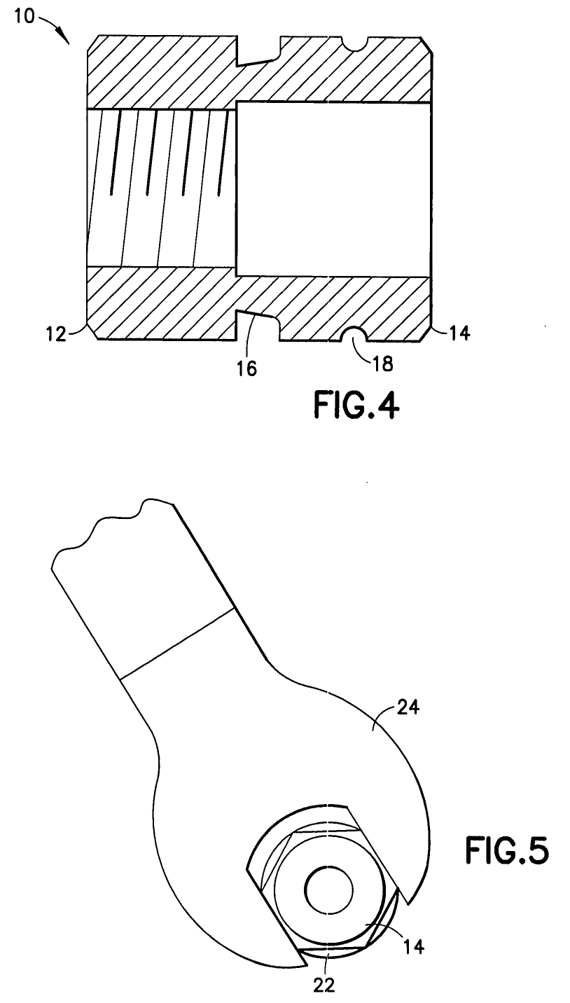

In this embodiment the first and second sections 12, 14 have generally hexagon shaped outer sides (best shown in FIG. 3). However, any suitable outer sides could be provided. The first section 12 has a threaded inner diameter (shown in FIG. 4). The second section 14 has a general non-threaded inner hole (shown in FIG. 4). The second section 14 has an annular groove 18 on its hexagon shaped outer side. The annular groove 18 may be formed within a middle portion of hexagon shaped outer side. However, it should be noted that the annular groove 18 may be formed within any suitable portion of the second section 14.

The retainer member 22 includes an O-ring member, such as made of resilient polymer or rubber material. However, in alternate embodiments the retainer member could comprise any suitable shape and/or comprise multiple members. The groove 18 in the break off section 14 of the break-away nut has the thin rubber O-ring 22 in the middle of the HEX portion. The O-ring 22 protrudes above the flat sections of the HEX so that it interferes with a wrench 24 (shown in FIG. 5) which is used to connect the fastener 10 to its mating fastener (not shown). Therefore, when the second section 14 separates from the first section 12, the second section can be held firmly in the wrench 24. Thus, as the wrench 24 is removed, the severed second section 14 is removed with the wrench 24.

FIG. 5 illustrates the second section 14 retained within the wrench 24. The O-ring 22 interferes with fastener mating areas of the wrench 24. This allows for the wrench 24 to retain the break off section 14 after the break off section 14 is severed or sheared at the third section 16. It should be understood that although FIG. 5 illustrates the severed second section 14 within a wrench, any suitable tool for fastening the nut may be provided.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A fastener nut comprising:
a first section having a threaded inner diameter;
a second section having an outer annular groove; and
a third section between the first section and the second section, wherein the first section, the second section, and the third section are integrally formed together as a one-piece member, and wherein the second section is configured to be removed from the first section at the third section.

2. The fastener nut of claim 1 wherein the annular groove is configured to receive a retaining member.

3. The fastener nut of claim 1 wherein the annular groove is configured to receive an O-ring.

4. The fastener nut of claim 1 wherein the third section is configured to fracture at a predetermined force.

5. The fastener nut of claim 1 wherein the second section comprises a hexagon shaped outer surface, and wherein the annular groove is formed within a middle portion of the hexagon shaped outer surface.

6. A fastener assembly comprising:
a fastener nut as in claim 1; and
a retaining member connected to the fastener nut.

7. A fastener assembly comprising:
a nut comprising a first section and a second section, wherein the first section has a threaded inner diameter, and wherein the second section is configured to break away from the first section; and
a retaining member connected to the second section, wherein the retaining member is configured to provide an interference fit between the second section and a mating tool.

8. The fastener assembly of claim 7 wherein the second section comprises an outer annular groove.

9. The fastener assembly of claim 8 wherein the retaining member is disposed within the outer annular groove.

10. The fastener assembly of claim 7 wherein the retaining member is an O-ring.

11. The fastener assembly of claim 7 wherein the second section comprises a hexagon shaped outer surface, and wherein the retaining member protrudes outwardly beyond the hexagon shaped outer surface.

12. The fastener assembly of claim 7 further comprising a third section, wherein the third section is between the first section and the second section, and wherein the second section is configured to break away from the first section at the third section.

13. The fastener assembly of claim 7 wherein the second section is configured to break away from the first section at a predetermined force.

14. A fastener assembly comprising:
a nut comprising a first section, a second section, and a third section, wherein the first section is configured to receive a bolt, wherein the second section has an outer annular groove, wherein the third section is between the first section and the second section, and wherein the third section is configured to fracture at a predetermined force; and
a retaining member disposed within the outer annular groove.

15. The fastener assembly of claim 14 wherein the first section, the second section, and the third section are integrally formed together as a one-piece member.

16. The fastener assembly of claim 14 wherein the second section comprises a hexagon shaped outer surface, and wherein the retaining member protrudes outwardly beyond the hexagon shaped outer surface.

17. The fastener assembly of claim 14 wherein the retaining member is configured to provide an interference fit between the second section and a mating tool.

18. The fastener assembly of claim 14 wherein the second section comprises a hexagon shaped outer surface, and wherein the annular groove is formed within a middle portion of the hexagon shaped outer surface.

19. The fastener assembly of claim 14 wherein the retaining member comprises a resilient polymer material.

20. The fastener assembly of claim 14 wherein the retaining member is an O-ring.
